(19) United States
(12) Patent Application Publication
(10) Pub. No.: US 2018/0317108 A1
(43) Pub. Date: Nov. 1, 2018

(54) NETWORK PERFORMED MEASUREMENTS

(71) Applicant: IPCom GmbH & Co. KG, Pullach (DE)

(72) Inventors: Andreas Schmidt, Braunschweig (DE); Achim Luft, Braunschweig (DE); Martin Hans, Bad Salzdetfurth (DE)

(21) Appl. No.: 15/772,393

(22) PCT Filed: Nov. 4, 2016
(86) PCT No.: PCT/EP2016/076677

§ 371 Date: Apr. 30, 2018

(30) Foreign Application Priority Data
Nov. 6, 2015 (EP) 15193482.5

(51) Int. Cl. H04W 24/08; H04L 12/26

(52) U.S. Cl. CPC H04W 24/08; H04L 43/0852

(57) ABSTRACT

The present invention provides a method of performing quality of service measurements on a packet data communication between a user equipment device and a remote server, wherein a packet data network gateway router performs latency measurements on routed data packets belonging to a specific session, correlating packets routed in an upward direction and packets routed in a downward direction, wherein the latency measurements are performed on a first segment between the user equipment device and the packet data network gateway and on a second segment between the packet data network gateway and the remote server without adding data to the routed data packets.

The present invention relates to measurements performed on an on-going communication between a user equipment (UE) device and a third party via network equipment.

Such measurements are known in connection with mobile communication, in particular measurements which are performed in order to provide for a so-called minimization of drive tests, MDT. MDT is a feature introduced in 3GPP Rel-10 that enables operators to utilize users' equipment to collect radio measurements and associated location information, in order to assess network performance while reducing the operational expenditure, OPEX, associated with traditional drive tests. MDT measurements may be collected by the eNB and/or by selected UEs, i.e. MDT measurements as they are defined today only take place in the Radio Access Network (RAN). The core network functionality for the configuration of MDT (comprising instructions what kind of devices should be selected for MDT measurements by the eNB, and where the collected MDT reports should be sent to) is based on the existing Trace functionality as described in 3GPP TS 32.422. Again, the current trace functionality does not enable measurements in core network entities.

An EPS bearer/E-RAB is the level of granularity for bearer level QoS control in the EPC/E-UTRAN. That is, Service Data Flows (SDFs) mapped to the same EPS bearer receive the same bearer level packet forwarding treatment (e.g. scheduling policy, queue management policy, rate shaping policy, RLC configuration, etc.).

SDF refers to a group of IP flows associated with a service that a user is using, while an EPS bearer refers to IP flows of aggregated SDFs that have the same QoS (Quality of Service) class, e.g. Conversational, Real Time Streaming or Best Effort. 3GPP TS 23.203 contains a list of standardized QoS Class Identifiers (QCIs) and corresponding example services.

One EPS bearer/E-RAB is established when the UE connects to a Packet Data Network (PDN), and this bearer remains established throughout the lifetime of the PDN connection to provide the UE with always-on IP connectivity to that PDN. That bearer is referred to as the default bearer. Any additional EPS bearer/E-RAB that is established to the same PDN is referred to as a dedicated bearer. The initial bearer level QoS parameter values of the default bearer are assigned by the network, based on subscription data. The decision to establish or modify a dedicated bearer can only be taken by the EPC, and the bearer level QoS parameter values are always assigned by the EPC.

An EPS bearer/E-RAB is referred to as a GBR bearer if dedicated network resources related to a Guaranteed Bit Rate (GBR) value that is associated with the EPS bearer/E-RAB are permanently allocated (e.g. by an admission control function in the eNodeB) at bearer establishment/modification. Otherwise, an EPS bearer/E-RAB is referred to as a Non-GBR bearer. A dedicated bearer can either be a GBR or a Non-GBR bearer while a default bearer shall be a Non-GBR bearer.

More information about the bearer service architecture in general and standardized QCI characteristics can be found in 3GPP TS 36.300 and 3GPP TS 23.203, respectively.

3GPP TS 32.421 and TS 32.422 describe a so-called “trace” feature. With the trace feature the mobile network is enabled to obtain a copy of all signalling messages belonging to a specific subscriber that are exchanged between the following entities: HSS, MME, S-GW, and P-GW. These network entities can be configured by the Element Manager (EM) to forward specific signalling messages to the TCE. Such configuration messages are for example sent during “UE attach” procedure from MME to S-GW and from S-GW to P-GW.

As described in 3GPP TS 32.422, a so called trace session may be configured and started in the Serving Gateway (SGW or S-GW) and Packet Data Network Gateway (PDN-GW, PGW or, as used herein, P-GW) from the Mobility Management Entity (MME) in the Create Session Request Messages. The trace functionality is originally triggered by the trace server (EMS in this case) via the Home Subscriber station (operator's subscriber data base) because the typical trace initiated is either location based (trace in a certain area) or subscriber based (trace a specific subscriber) and the data base is the first entry point that has the information which subscriber is currently located where or which MME serves a certain area. The MME then propagates the trace session to the respective network entities: SGW, PGW and eNB. The trace configuration is propagated from the S-GW to the P-GW together with the UE-specific configuration for bearer setup and other information.

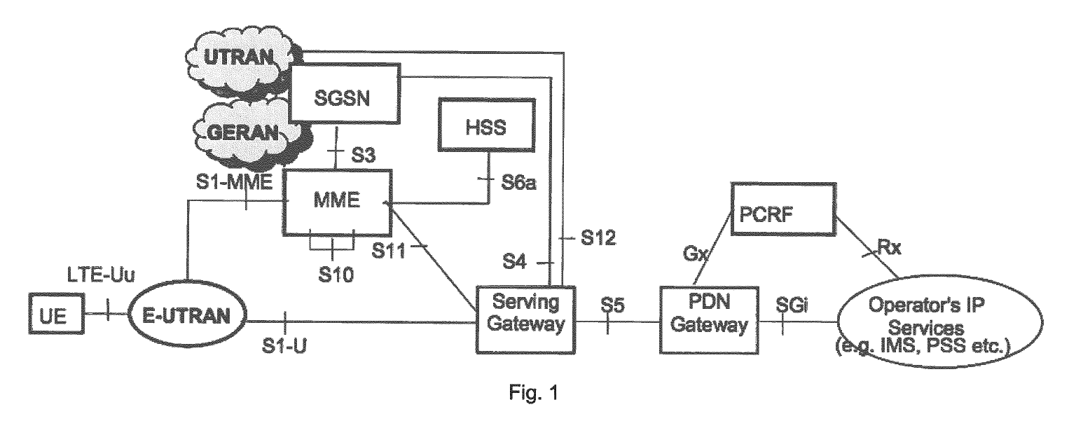

To aid the reader in understanding the invention, a schematic diagram of the different interfaces involved in a LTE communication network are illustrated in FIG. 1.

As mentioned above, the original trace functionality allows tracing of signalling messages, which basically means collecting a copy of messages that were exchanged between entities; no measurements are possible.

For a complete understanding of the present invention, an understanding of data transport protocols is useful.

Internet Protocol version 4 (IPv4) is the most commonly implemented version of the Internet Protocol (IP). It is one of the core protocols of standards-based internetworking methods in the Internet. It still routes most Internet traffic today despite the on-going deployment of a successor protocol, IPv6. IPv4 is described in IETF publication RFC 791.

Internet Protocol version 6 (IPv6) is the most recent version of the Internet Protocol (IP). As IPv4 before IPv6 was developed by the Internet Engineering Task Force (IETF) to deal with the long-anticipated problem of IPv4 address exhaustion. IPv6 is replacing IPv4 step-by-step.

With the specification of IPv6, all new features of IPv6 have been introduced to IPv4 as optional features with the help of so called optional headers; these new features are for example IPsec and Mobile IP. Fragmentation caused by maximum transmission units (MTUs) with different sizes is an IPv4 only problem. In IPv6 there exist mechanisms to adjust the MTU in order to avoid fragmentation.

In IPv6, the packet header and the process of packet forwarding have been simplified. Although IPv6 packet headers are at least twice the size of IPv4 packet headers, packet processing by routers is generally more efficient, because less processing is required in routers.

The packet header in IPv6 is simpler than the IPv4 header. Many rarely used fields have been moved to optional header extensions. The IPv6 header is not protected by a checksum. Integrity protection is assumed to be assured by both the link layer or error detection and correction methods in higher-layer protocols, such as TCP or UDP.

As mentioned above IPv6 routers do not perform IP fragmentation. IPv6 hosts are required to either perform path MTU (Maximum Transfer Unit) discovery, perform end-to-end fragmentation, or to send packets no larger than the default MTU, which is 1280 octets.

The Transmission Control Protocol (TCP) is another core protocol of the Internet Protocol suite. Therefore, the entire suite is commonly referred to as TCP/IP. TCP provides reliable, ordered, and error-checked delivery of a stream of octets (datagrams) between applications running on hosts communicating over an IP network. TCP is a “connection aware” protocol. Applications that do not require reliable data stream service (like video streaming) may use the User Datagram Protocol (UDP), which provides a connectionless datagram service that emphasizes reduced latency over reliability.

While the first mobile communication networks were concerned with the transmission of voice signals, modern networks are constructed to transmit packet data and accordingly, the network infrastructure requires such capability, including routers.

A router is a networking entity that forwards data packets between computer networks. A router is connected to two or more data lines from different networks (as opposed to a network switch, which connects data lines from one single network). In 3GPP the packet data network gateway, P-GW, is connected to the Enhanced Packet Core-Network (EPC) and the internet backbone. When a data packet comes in on one of the lines, the router reads the address information in the packet to determine its ultimate destination. Then, using information in its routing-table or routing policy, it directs the packet to the next network. This creates an overlay internetwork. Routers perform the “traffic directing” functions on the Internet. A data packet is typically forwarded from one router to another through the networks that constitute the internetwork until it reaches its destination node.

A router has two modes of operation:

Control: A router maintains a routing-table that lists which route should be used to forward a data packet, and through which physical interface connection. It does this by learning routes using a dynamic routing protocol. Dynamic routes are stored in the Routing Information Base (RIB). The control-plane logic then strips the RIB from non essential directives and builds a Forwarding Information Base (FIB) to be used by the forwarding function.

Forward: The router forwards data packets between incoming and outgoing interface connections. It routes them to the correct network type using information that the packet header contains. It uses data recorded in the routing-table.

The P-GW is the gateway which terminates the SGi interface towards the PDN.

P-GW functions include:
Per-user based packet filtering (Deep Packet Inspection and Lawful Interception) UE IP address allocation (DHCPv4/6 client and server functions)
Transport level packet marking in the uplink and downlink, e.g. setting the DiffSery Code Point, based on the QCI of the associated EPS bearer
UL and DL service level gating control and rate enforcement as defined in TS 23.203
UL and DL bearer binding and verification as defined in TS 23.203
Neighbour Discovery for IPv6 as defined in RFC 4861
Accounting per UE and bearer (also inter-operator accounting)

Bearer binding is the association of the PCC rule and the QoS rule (if applicable) to an IP-CAN bearer within that IP-CAN session.

For an IP-CAN which allows for multiple IP-CAN bearers for each IP-CAN session, the binding mechanism shall use the QoS parameters of the existing IP-CAN bearers to create the bearer binding for a rule, in addition to the PCC rule and the QoS rule (if applicable).

The set of QoS parameters to the service data flow is the main input for bearer binding.

The Bearer Binding Function (BBF) shall evaluate whether it is possible to use one of the existing IP-CAN bearers or not and whether initiate IP-CAN bearer modification if applicable. If none of the existing bearers are possible to use, the BBF should initiate the establishment of a suitable IP-CAN bearer. The binding is created between service data flow(s) and the IP-CAN bearer which have the same QoS class identifier and ARP.

Whenever the QoS authorization of a PCC rule changes, the existing bindings shall be re-evaluated, i.e. the bearer binding procedures specified in this clause, is performed. The re-evaluation may, for a service data flow, require a new binding with another IP-CAN bearer.

Today P-GW has a trace session functionality. That is, IP packets can be traced or copied to a Trace Collecting Entity (TCE). It is not possible to configure P-GW in a way that it performs measurements on the traffic and reports the result of such measurements to TCE.

In prior-art mobile networks, there is no latency measurement in P-GW separated in both connected networks (the EPC-RAN on one interface of P-GW and the internet on another interface of P-GW) possible.

Flow-labelling or injection of specific packets into data flows to assess data transfer on the basis of these packets is known. Both labelling and injections influence the to-be-measured data-flow and may distort the measurement itself or may not assess the right measures, e.g. because injected packets take a different path than the actual data traffic.

US 2015/0063132 A1 describes a mechanism for determining an available bandwidth of a network. Special discovery packets are sent from one network device to identify routers between first and second network devices and then for each discovered router, latency measurements are made by measuring responses to the discovery packets.

3GPP TS 32.426 v. 12.0.0 describes, in section 5, measurement of bearer modification with and without QoS update.

US 2014/0113656 A1 describes a technique for a mobile communication network to obtain results of measurements performed by a UE in so-called “minimization of drive tests”, MDT. One of the measurements which the UE may make is that of QoS class.

U.S. Pat. No. 8,040,803 describes obtaining packet transport metrics and using these for call admission control. While it is indicated that the metrics can be measured between a mobile station and the other endpoint or between a network element and the other endpoint, it is not indicated how this should be performed.

A fully transparent measurement of user-specific and service-specific end-to-end QoS in P-GW separated in the two connected networks without adding data to the routed packets itself is provided by the present invention.

The present invention provides a method of performing quality of service measurements on a packet data communication between a user equipment device and a remote server, wherein a packet data network gateway router performs latency measurements on routed data packets belonging to a specific session, correlating packets routed in an upward direction and packets routed in a downward direction, wherein the latency measurements are performed on a first segment between the user equipment device and the packet data network gateway and on a second segment between the packet data network gateway and the remote server without adding data to the routed data packets.

Further preferred aspects of the invention are provided according to the dependent claims. The invention also provides a corresponding P-GW for implementing the method as well as mobile core network entities which interface with the P-GW.

By means of the invention, the deficiencies of the prior art are addressed by introducing latency measurements to the P-GW separated in the following routing segments:
UE-P-GW
P-GW-Application Server in the Internet

The trace functionality for reporting of these measurements is enhanced, as is the parameterization of the UE-P-GW routing segment in dependency to the separated latency measurements as follows.

A mobile network router, e.g. the P-GW, is enabled to perform latency measurements on routed data traffic separated into the two routing segments mentioned above.

These measurements are performed taking network, transport and/or session layer information of the routed data into account, without manipulating the data and in particular without including reference IP packets or adding IP header fields.

These measurements are performed by correlation of packets routed in uplink direction and packets routed in downlink direction and by derivation of a timing relationship between the respective packets. Multiple such measurements are analysed statistically in the router to result in meaningful measures, e.g. by averaging latency measurements and calculating their standard deviation (jitter). Routing parameters of the route segment UE-P-GW are set corresponding to the results of these measurements is separately for both routing segments. Trace session configuration is enhanced to allow for reporting of such measurements and for triggering trace reports based on events in relation to the measurements themselves (e.g. exceeding thresholds) or general time (e.g. periodic reporting), the triggers being dynamically configurable

An entity of the mobile core network (e.g., some kind of “evolved” EM) is enabled to configure the P-GW for latency measurements mentioned above, for trigger events for these latency measurements and for event-based or regular reporting of these measurements.

An entity of the mobile core network (e.g., a form of “evolved” ICE) is enabled to collect and evaluate the service-specific measurements received from the P-GW.

Latency information about both routing segments is included as part of the measurements in order to reflect the actual user experience with a specific service. It is not desirable to involve the respective terminating network nodes which would be the UE and the 3rd party service provider's server in the internet. The reason for this is that neither existing QoS measurements nor special data packets transferred between UE and server would reflect the actual user experience of the actual service quality; e.g. HD video streaming. It is beneficial to minimize the impact on the UE and any 3rd party servers. It is also beneficial to divide the measurements into two routing segments: one that cannot be changed and one that can be influenced by parameter setting, bearer selection and QoS selection.

It is part of the invention to optimize the routing segments that can be influenced dependently on the results of the measurements of the route segment that cannot be changed. E.g., if the main latency is caused between P-GW and a server it might not be efficient to optimize the route segment between P-GW and UE with high costs since the e2e QoS/user experience is based on the other segment. It is also beneficial to derive these separated measurements in the P-GW from the actual traffic between the UE-P-GW and P-GW and a 3rd party service provider's server. In order to perform such measurements in the P-GW the gateway has to analyse packets on TCP level although routing is on IP level. Service specific and packets related to one connection in both directions (uplink and downlink) have to be considered as input for these measurements.

The invention provides the substantial benefit to the network operator of new in-transport latency measurements specific to the routing segments in P-GW. The measurements are generated in the P-GW by performing fully transparent measurements of routing segment specific measurements without adding data to the routed packets itself nor marking related packets, as all such methods would impact the actual measurements. The measurements may be mainly latency related but can also include error rate (re-transmissions), jitter, fragmentation (e.g. because of different MTUs). There is no need for interworking with external networks such as 3rd party service provider's servers in the Internet. The measurements are on the exact same IP flow/path as the actual service data. The EPC-RAN routing segment can be optimized or parameterized dependently on the proportion of the results in both routing segments.

Embodiments of the invention will now be described, by way of example only, with reference to the accompanying drawings in which:

FIG. 1 shows a schematic representation of a LTE mobile communication network; and

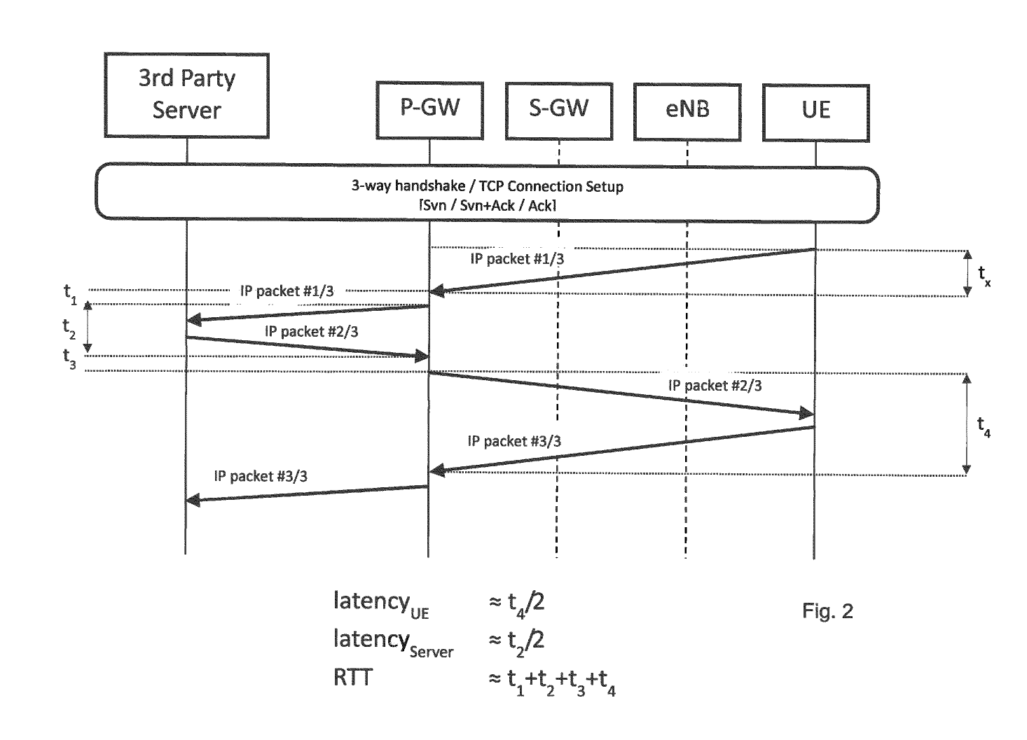

FIG. 2 shows a schematic representation of uplink and downlink latency measurement.

TCP/IP flows can be defined by a 5-tuple of IP related values: Destination IP address, source IP address, destination port, source port, and protocol in use; mainly TCP or UDP.

A network entity with routing functionality needs at least the following functions:
routing protocols (e.g. OSPF, IS-IS) in order to maintain a routing-table
a forward-table generated based on the routing table
basic TCP/IP functionality like loop cancelation, header integrity checks (IPv4), fragmentation, etc.

Although not necessarily needed for pure routing/forwarding in the 3GPP EPC, a P-GW may map IP packets to IP flows with the whole 5-tuple. Based on the 5-tuple additional functions are performed such as IP-flow selection and bearer selection. Being aware of the 5-tuple it is possible for the P-GW to correlate the IP packets that have been sent from UE to a 3rd party server and the related IP packets that have been returned from the server to the UE. In other words, packets that belong to the same session may be identified. Furthermore, it is possible to find packets within a session that have a fixed timing relation, e.g. if the reception of one packet by the third party server directly triggers the transmission of a packet back to the UE like TCP ACK packets.

Referring to FIG. 1, in the present invention, a P-GW acts as a network element that routes data traffic between two routing segments and impacts only one of these two segments performs such measurements in two routing segments separately (e.g. latency_UE and latency_{—} Server) and parameterizes the EPC-RAN segment accordingly based on an evaluation of the results.

After correlation of identified packets belonging to a specific session, the P-GW can perform a number of measurements separated on both routing segments. These measurements are for example:

(I) Latency

Statistically the latency for each direction and each routing segment can be calculated. The latency measurements are illustrated in FIG. 2.

(ii) Jitter

Jitter is the deviation from true periodicity of a presumed periodic value. The jitter in terms of latency can be measured for both routing segments.

(iii) Re-Transmission Rate

TCP provides reliable, ordered, and error-checked delivery of a stream of octets between applications running on hosts communicating over an IP network. In case of packets not received (time-out) or errors not correctable TCP request re-transmissions of lost packets. Re-Transmissions are signalled in the IP header and the re-transmission rate can therefore be measured in the P-GW. It indicates the error rate or lost rate and the overhead caused by re-transmissions. P-GW is also able to distinguish in which routing segment the retransmission or packet loss is caused.

(iv) Fragmentation Rate

In computer networking, the maximum transmission unit (MTU) of a communications protocol of a layer is the size of the largest protocol data unit that the layer can pass onwards. In TCP/IPv4 packets sent from a network with a larger MTU to a network with a smaller MTU have to be fragmented into several packets. Fragmentation causes overhead through the duplication of IP and TCP headers and should be minimized. The fragmentation rate is therefore an important in-transmission measurement that has to be performed on actual data and not artificially generated test data packets. Again it is important for the network parameterization in which routing segment fragmentation is caused.

The PGW and S-GW depicted in FIG. 2 are configured with trace functionality by the MME.

In this invention the existing configuration with measurement and report configuration information and rules for network parameterization based on the proportions of the measurement results in both routing segments are enhanced.

The P-GW is a network node that can provide its trace records to the TCE. The measurement reports may be sent to TCE either per routing segment or in an consolidated (pre-processed) manner.

The existing trace records from PGW to TCE that currently only contain exchanged control messages are enhanced by the in-transport measurement reports.

It is to be noted that while embodiments of the invention have been described in connection with an E-UTRA (i.e. LTE) network, using LTE terminology, the invention may also be put into effect in other networks, for example HSPA described in the UMTS suite of standards using the principles of the invention.

As an illustrative example of the use of the invention, if User A is streaming a video in high-definition from a video streaming service to a mobile device. In P-GW latency_UE and latency_Server is measured by correlating the TCP packets of this video streaming session. If Latency_UE (t₄/2) is 100 ms and latency_Server (t₂/2) is 75 ms, L=200 ms represents a significant part of the round trip time, RTT, (t₁+t₂+t₃+t₄) which is in this example 365 ms, the P-GW might therefore set the session flow to an IP-flow with a HD video optimizer in it. This decreases latency_UE from 100 ms to 50 ms and the RTT from 365 ms to 265 ms. The user experience is significantly increased and the HD video optimizer as a resource is efficiently used.

If User B is also streaming a video in standard definition from the video streaming service to a tablet PC in which Latency_UE is 100 ms, latency_Server is 375 ms and RTT is 965 ms, although this high RTT results into a bad user experience, the P-GW would not optimizing the EPC-RAN routing segment e.g. by switching to a video optimized IP-flow because t₄ is an irrelevant part of RTT that is mainly caused by t₂. Additional allocated resources such as a video optimizer would not lead to a much better user experience for User B and could be allocated to another user in a more efficient way.

1. A method of performing quality of service measurements on a packet data communication between a user equipment device and a remote server, wherein a packet data network gateway router performs latency measurements on routed data packets belonging to a specific session, correlating packets routed in an upward direction and packets routed in a downward direction, wherein the latency measurements are performed on a first segment between the user equipment device and the packet data network gateway and on a second segment between the packet data network gateway and the remote server without adding data to the routed data packets.

2. The method of claim 1, wherein packets belonging to the specific session are identified by analyzing at least one of network, transport and session layer information.

3. The method according to claim 1, wherein for the specific session a plurality of measurements are performed and results of the plurality of measurements are analyzed statistically.

4. The method according to claim 3, wherein the statistical analysis is performed to determine at least one of a jitter value, a re-transmission rate and a fragmentation rate.

5. The method according to claim 1, further including sending a measurement report to a network entity, preferably a trace collection entity, TCE.

6. The method according to claim 1, wherein the measurements are used to optimize a connection routing.

7. A packet data network gateway router adapted to performs latency measurements on routed data packets belonging to a specific session, correlating packets routed in an upward direction and packets routed in a downward direction, wherein the router is arranged to perform the latency measurements on a first segment between a user equipment device and the packet data network gateway and on a second segment between the packet data network gateway and a remote server without adding data to the routed data packets.

8. A mobile core network entity arranged to configure a packet data network gateway router such that router performs latency measurements on routed data packets belonging to a specific session, correlating packets routed in an upward direction and packets routed in a downward direction, wherein the latency measurements are performed on a first segment between a user equipment device and the packet data network gateway and on a second segment between the packet data network gateway and a remote server without adding data to the routed data packets.

9. The mobile core network entity according to claim 8, further arranged to collect and evaluate measurements received from the packet data network gateway router.
